(19) United States
(12) Patent Application Publication
(10) Pub. No.: US 2024/0249637 A1
(43) Pub. Date: Jul. 25, 2024

(54) ADVERSARIAL SIMULATION FOR DEVELOPING AND TESTING ASSISTIVE DRIVING TECHNOLOGY

(71) Applicant: Toyota Research Institute, Inc., Los Altos, CA (US)

(72) Inventors: Simon Stent, Cambridge, MA (US); Andrew P. Best, Sunnyvale, CA (US); Shabnam Hakimi, San Francisco, CA (US); Guy Rosman, Newton, MA (US); Emily S. Sumner, Mountain View, CA (US); Jonathan DeCastro, Arlington, MA (US)

(73) Assignees: Toyota Research Institute, Inc., Los Altos, CA (US); Toyota Jidosha Kabushiki Kaisha, Aichi-ken (JP)

(21) Appl. No.: 18/156,591

(22) Filed: Jan. 19, 2023

(51) Int. Cl. G09B 9/05

(52) U.S. Cl. CPC G09B 9/05

(57) ABSTRACT

A driving simulator may include a controller programmed to simulate operation of a vehicle being driven by a driver, the vehicle including assistive driving technology, receive driver data associated with the driver, determine whether the driver is distracted based on the driver data, and upon determination that the driver is distracted, simulate a particular driving event.

### TECHNICAL FIELD

The present specification relates to testing of assistive driving technology, and more particularly to adversarial simulation for developing and testing assistive driving technology.

### BACKGROUND

Many modern vehicles include a variety of assistive driving technologies that may perform certain driving functionalities in a variety of situations. For example, vehicles may include lane assist to keep a vehicle within a particular lane, collision avoidance to avoid collisions with other objects, and the like. These assistive driving technologies typically operate in a semi-autonomous manner. That is, a human driver is still largely in control of a vehicle but one or more assistive driving technologies may intervene in certain situations.

One situation in which assistive driving technologies may be useful is when a human driver is distracted or otherwise impaired. As such, it may be desirable to test assistive driving technologies when a driver is distracted or impaired. Testing of assistive driving technologies may be performed in a simulated environment. For example, a driving simulator may allow a human to experience simulated driving events and perform driving actions on hardware that is similar to an actual vehicle. However, it may be difficult to create an artificial situation in which a driver is distracted, and it may be difficult to recruit test subjects having certain impairments. Accordingly, improved methods of adversarial simulation for developing and testing assistive driving technology may be desired.

### SUMMARY

In one embodiment, a driving simulator may include a controller programmed to simulate operation of a vehicle being driven by a driver the vehicle including assistive driving technology, receive driver data associated with the driver, and determine whether the driver is distracted based on the driver data. Upon determination that the driver is distracted, the controller may simulate a particular driving event.

In another embodiment, a method may include simulating operation of a vehicle being driven by a driver, the vehicle including assistive driving technology, receiving driver data associated with the driver, and determining whether the driver is distracted based on the driver data. Upon determination that the driver is distracted, the method may include simulating a particular driving event.

In another embodiment, a driving simulator may include a controller programmed to simulate operation of a vehicle being driven by a driver, the vehicle including assistive driving technology, receive driver data associated with the driver, and determine whether the driver is distracted based on the driver data. Upon determination that the driver is distracted, the controller may generate an impairment associated with the driver.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an example driving simulator, according to one or more embodiments shown and described herein;

FIG. 2 depicts an example computing system included in the driving simulator of FIG. 1, according to one or more embodiments shown and described herein;

FIG. 3 depicts memory modules of the computing system of FIG. 2, according to one or more embodiments shown and described herein;

FIG. 4 depicts a flowchart of an example method of operating the driving simulator of FIG. 1, according to one or more embodiments shown and described herein; and

FIG. 5 depicts a flowchart of another example method of operating the driving simulator of FIG. 1, according to one or more embodiments shown and described herein.

### DETAILED DESCRIPTION

The embodiments disclosed herein describe systems and methods for adversarial simulation for developing and testing assistive driving technology. In embodiments disclosed herein, a driver may operate a driving simulator. The driving simulator may display a screen to the driver showing a simulated driving environment. The driving simulator may include a steering wheel, brake and accelerator pedals, and other input devices that the driver may use to perform driving actions in a similar manner as if they were driving an actual vehicle. As the driver performs driving actions, the driving simulator may update the driving environment on the screen based on the actions of the driver.

Additionally, the driving simulator may include driver monitoring equipment, such as a camera or other sensors, to monitor the state of the driver. The driver monitoring equipment may detect when the driver is distracted. When the driver monitoring equipment detects that the driver is distracted, the driving simulator may generate a driving scenario to be tested when the driver is distracted. For example, the driving simulator may simulate a pedestrian or another vehicle entering the road once the driver monitoring equipment detects that the driver is distracted. The driving simulator may also include assistive driving technology to be tested. As such, embodiments disclosed herein may allow the driving simulator to test assistive driving technology in a scenario in which a driver is genuinely distracted, thereby generating more realistic test conditions. In some examples, the driving simulator may also generate artificial impairments in order to test assistive driving technology for use with impaired drivers (e.g., drivers who are deaf, have visual impairments, and the like) without the need to recruit actual test subjects having specific visual impairments, as disclosed herein.

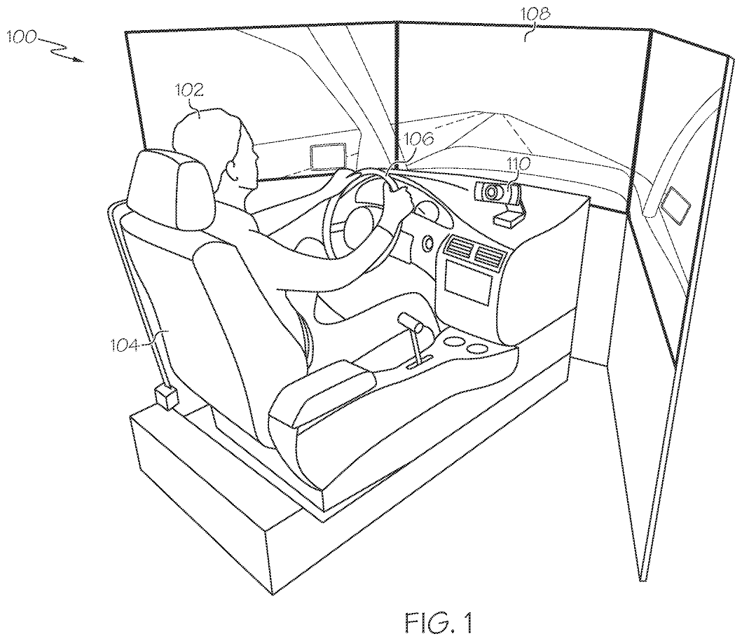

Turning now to the figures, FIG. 1 depicts an example driving simulator 100. In the example of FIG. 1, a driver 102 operates the driving simulator 100 as if they were driving an actual vehicle. In the example of FIG. 1, the driver 102 sits in a seat 104 and controls operation of the driving simulator 100 with a steering wheel 106 or other input devices (e.g., pedals, gear shift mechanism, and the like). A screen 108 displays a driving environment to the driver 102. The driving environment may be updated based on driving actions taken by the driver (e.g., accelerating or turning) and based on scenarios generated by the driving simulator 100 (e.g., simulated actions of other vehicles or road agents). In some examples, a speaker inside the driving simulator 100 may generate audio to simulate sounds that may be heard while driving.

In the example of FIG. 1, the driving simulator 100 also includes a camera 110. In the illustrated example, the camera 110 continually captures images of the driver 102. The images captured by the camera 110 may be used to determine whether the driver 102 is distracted, as disclosed herein. As such, when the driver 102 is distracted, the driving simulator 100 may trigger certain driving scenarios in order to test operation of one or more assistive driving technologies with a distracted driver.

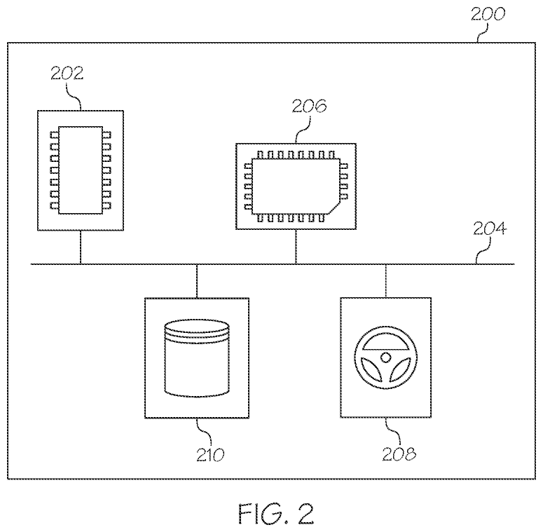

FIG. 2 depicts an example computing system 200 included in the driving simulator 100 of FIG. 1. The computing system 200 includes one or more processors 202, a communication path 204, one or more memory modules 206, one or more driving input devices 208, and one or more driver monitor sensors 210, the details of which will be set forth in the following paragraphs. It should be understood that the computing system 200 of FIG. 2 is provided for illustrative purposes only, and that other computing systems 200 comprising more, fewer, or different components may be utilized.

Each of the one or more processors 202 may be any device capable of executing machine readable and executable instructions. Accordingly, each of the one or more processors 202 may be a controller, an integrated circuit, a microchip, a computer, or any other computing device. The one or more processors 202 are coupled to a communication path 204 that provides signal interconnectivity between various modules of the computing system 200. Accordingly, the communication path 204 may communicatively couple any number of processors 202 with one another, and allow the modules coupled to the communication path 204 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 204 may be formed from any medium that is capable of transmitting a signal such as, for example, conductive wires, conductive traces, optical waveguides, or the like. In some embodiments, the communication path 204 may facilitate the transmission of wireless signals, such as WiFi, Bluetooth®, Near Field Communication (NFC) and the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Accordingly, the communication path 204 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The example computing system 200 includes one or more memory modules 206 coupled to the communication path 204. The one or more memory modules 206 may comprise RAM, ROM, flash memories, hard drives, or any device capable of storing machine readable and executable instructions such that the machine readable and executable instructions can be accessed by the one or more processors 202. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 206. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

Referring still to FIG. 2, the example computing system 200 comprises one or more driving input devices 208. The driving input devices 208 may allow the driver 102 to perform driving actions within the driving simulator 100. In particular, the driving input devices 208 may allow the driver 102 to control driving operations of a vehicle being simulated by the driving simulator 100. In the illustrated example, the driving input devices 208 include the steering wheel 106 of FIG. 1. The driving input devices 208 may also include other hardware to allow the driver 102 to perform actions, such as a brake pedal, an accelerator pedal, a clutch, and the like.

Referring still to FIG. 2, the example computing system 200 comprises one or more driver monitor sensors 210. Each of the one or more driver monitor sensors 210 is coupled to the communication path 204 and communicatively coupled to the one or more processors 202. In embodiments, the driver monitor sensors 210 may monitor the driver 102. The computing system 200 may determine whether the driver 102 is distracted based on the data collected by the driver monitor sensors 210, as disclosed herein. In the illustrated example, the driver monitor sensors 210 include the camera 110. However, in other examples, the driver monitor sensors 210 may include other sensors such as biological sensors that measure biological data of the driver 102, among other types of sensors.

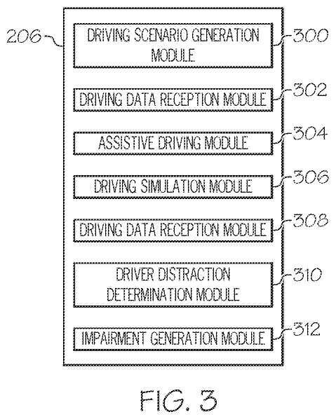

Now referring to FIG. 3, the one or more memory modules 206 of the computing system 200 include a driving scenario generation module 300, a driving data reception module 302, an assistive driving module 304, a driving simulation module 306, a driver data reception module 308, a driver distraction determination module 310, and an impairment generation module 312. Each of the driving scenario generation module 300, the driving data reception module 302, the assistive driving module 304, the driving simulation module 306, the driver data reception module 308, the driver distraction determination module 310, and the impairment generation module 312 may be a program module in the form of operating systems, application program modules, and other program modules stored in the one or more memory modules 206. Such a program module may include, but is not limited to, routines, subroutines, programs, objects, components, data structures and the like for performing specific tasks or executing specific data types as will be described below.

The driving scenario generation module 300 may generate driving scenarios to be encountered by the driver 102 in the driving simulator 100. In particular, the driving scenario generation module 300 may simulate the presence of obstacles and/or other road agents to be encountered by the driver 102 while performing simulated driving. For example, the driving scenario generation module 300 may simulate obstacles such as pot holes or debris to be encountered by the driver 102 in the simulated driving environment. The driving scenario generation module 300 may simulate the presence and/or behavior of traffic infrastructure, such as stops signs or stop lights.

The driving scenario generation module 300 may also simulate other road agents such as pedestrians or other vehicles. For example, the driving scenario generation module 300 may control the behavior of simulated vehicles within the simulated driving environment encountered by the driver 102 while operating the driving simulator 100. In some examples, the driving scenario generation module 300 may simulate particular driving situations for which testing data is desired. For example, the driving scenario generation module 300 may generate a situation in which another vehicle suddenly pulls in front of the simulated vehicle being controlled by the driver 102. In some examples, the driving scenario generation module 300 may generate particular driving scenarios upon determination that the driver 102 is distracted, as discussed in further detail below.

The driving data reception module 302 may receive data from the driving input devices 208. For example, as the driver 102 operates the driving simulator 100 to perform driving of a simulated vehicle, the driver 102 may operate the steering wheel 106 and other driving functionality, such as operating the brake and accelerator pedals. As the driver 102 operates the driving input devices 208, the driving data reception module 302 may receive data indicating the driving actions taken by the driver with the driving input devices 208. The data received by the driving data reception module 302 may be used to control the vehicle simulation, as disclosed in further detail below.

The assistive driving module 304 may implement assistive driving technology. As discussed above, many vehicles include assistive driving technology to perform semi-autonomous driving functions. For example, an assistive driving technology feature may monitor a vehicle and the vehicle's environment and perform particular driving actions in certain situations. For example, a lane-assist feature may adjust steering of a vehicle if the vehicle starts to veer out of its lane, or collision avoidance feature may apply vehicle brakes to avoid a collision if the vehicle gets too close to another vehicle.

In embodiments, the assistive driving module 304 may implement assistive driving technology for the vehicle being simulated by the driving simulator 100. In particular, the assistive driving module 304 may receive data about the simulated driving environment maintained by the driving simulator 100, as well as driving actions performed by the driver 102. The assistive driving module 304 may then output driving actions to be performed by the simulated vehicle if conditions are warranted. For example, the assistive driving module 304 may implement collision avoidance by causing the simulated vehicle to apply the vehicle brake if the simulated vehicle gets too close to another simulated vehicle. As such, the assistive driving module 304 may allow assistive driving technologies to be tested in a simulated environment. In particular, assistive driving technologies may be tested while the driver 102 is distracted, as disclosed in further detail below.

The driving simulation module 306 may manage the vehicle simulation of the driving simulator 100. In particular, the driving simulation module 306 may receive driving scenario data generated by the driving scenario generation module 300, driving data received by the driving data reception module 302, and driving instructions output by the assistive driving module 304, and may update and maintain a state of the vehicle being simulated and the simulated vehicle environment. In particular, the driving simulation module 306 may update the simulated position, speed, and other data associated with the simulated vehicle based on the received data. For example, if the driver 102 turns the steering wheel 106, the driving simulation module 306 may update the direction that the simulated vehicle is heading.

After updating the state of the simulated vehicle and the vehicle environment, the driving simulation module 306 may cause the screen 108 to display a scene indicative of the updated driving state and driving environment. In embodiments, the driving simulation module 306 may continually receive data from the driving scenario generation module 300, the driving data reception module 302, and the assistive driving module 304, and may continually update the image displayed on the screen 108 based on the updated vehicle state and driving environment. As such, assistive driving technology may be tested in a simulated driving environment. In some examples, the driving simulation module 306 may also generate audio sounds indicative of the driving state and driving environment. In some examples, the driving simulation module 306 may cause the seat 104 or other components inside the driving simulator 100 to vibrate or otherwise move to simulate physical sensations that may occur while driving.

The driver data reception module 308 may receive data about the driver 102. In particular, the driver data reception module 308 may receive data from the driver monitor sensors 210. In the illustrated example, the driver data reception module 308 may receive images captured by the camera 110. For example, the camera 110 may be trained on the face of the driver 102, and the driver data reception module 308 may receive captured images of the driver's face. However, in other examples, the driver data reception module 308 may receive data from other driver monitor sensors 210. For example, the driver data reception module 308 may receive data indicating biological data of the driver 102, such as a pulse rate or other vital signs. In other examples, the driver data reception module 308 may receive data about pupil dilation of the driver 102, a hand or body pose of the driver 102, whether the driver 102 has been operating the vehicle pedals, and the like. The data received by the driver data reception module 308 may be used to determine whether the driver 102 is distracted, as disclosed in further detail below.

The driver distraction determination module 310 may determine whether the driver 102 is distracted based on the data received by the driver data reception module 308, as disclosed herein. The driver distraction determination module 310 may utilize a variety of factors to determine whether the driver 102 is distracted. For example, the driver distraction determination module 310 may determine that the driver 102 is distracted if the driver's eyes are gazing in a particular direction, if the driver's pupils are dilated a certain amount, if the driver's eyes are closed for a certain time period, or if the driver 102 has a certain hand or body pose, such as the driver's hands being off the steering wheel 106 for a certain amount of time or the driver's feet being off the pedals for a certain amount of time. The driver distraction determination module 310 may also determine that the driver 102 is distracted based on biological or vital sign data, for example, if the driver's pulse falls below a certain level.

While the driver distraction determination module 310 is described herein as determining whether the driver 102 is distracted, it should be understood that in other examples, the driving simulator 100 may determine whether the driver 102 is in a state other than distraction based on data received by the driver data reception module 308. For example, the driving simulator 100 may determine whether the driver 102 is tired, nervous, excited, or in any other abnormal state. The driving simulator 100 may utilize different criteria to determine different states of the driver 102. As such, the driving simulator 100 may test assistive driving technologies when the driver 102 is in a variety of different abnormal states.

The impairment generation module 312 may generate an artificial impairment associated with the driver 102. As such, the driving simulator 100 may allow for assistive driving technology to be tested on drivers having certain impairments. For example, it may be desirable to test a particular assistive driving technology with a driver who is deaf or visually impaired. However, as discussed above, it may be difficult to recruit actual test subjects having particular impairments. Thus, the impairment generation module 312 may artificially generate an impairment.

For example, to artificially simulate a driver with a visual impairment, the impairment generation module 312 may blur the images presented on the screen 108. To artificially simulate a deaf driver, the impairment generation module 312 may generate distorted audio. In some examples, the impairment generation module 312 may generate an impairment associated with driving input devices 208. For example, the impairment generation module 312 may modify the driving data received by the driving data reception module 302. For example, the impairment generation module 312 may cause the steering wheel 106 to turn a smaller or greater amount than expected by the driver 102, thereby simulating equipment malfunction or driver error.

In some examples, the impairment generation module 312 may generate an artificial impairment throughout a driving simulation. In other examples, the impairment generation module 312 may generate one or more driving impairments after certain events, such as when the driver distraction determination module 310 determines that the driver 102 is distracted.

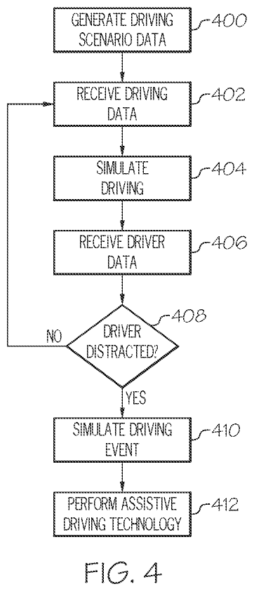

Turning now to FIG. 4, a flowchart is depicted of an example method of operating the driving simulator 100. At step 400, the driving scenario generation module 300 generates driving scenario data to be used to simulate a driving trip. The driving scenario data may include positions of traffic infrastructure, behavior of other road agents, and the like. In some examples, a human may program the driving scenario data to test a particular driving situation. In other examples, the driving scenario data may be partially or fully computer generated.

At step 402, the driving data reception module 302 receives driving data based on driving actions performed by the driver 102. For example, the driving data may include data about the driver's operation of the steering wheel 106, vehicle pedals, and the like.

At step 404, the driving simulation module 306 simulates driving of a vehicle based on the driving scenario data generated by the driving scenario generation module 300 and the driving data received by the driving data reception module 302. In particular, the driving simulation module 306 may update a driving state of the simulated vehicle, and environment data about the location of the vehicle and behavior of other simulated road agents. As such, as the driver 102 performs driving actions in the driving simulator 100, the driving simulation module 306 may perform calculations to simulate what the driver 102 would see based on those driving actions and the environment data. The driving simulation module 306 may cause the screen 108 to continually update with a simulated view of the driving environment around the simulated vehicle based on the driving scenario data and the driving actions performed by the driver 102. In some examples, the driving simulation module 306 may generate audio based on the driving scenario data and the driving actions performed by the driver 102.

At step 406, the driver data reception module 308 receives driver data from the driver monitor sensors 210. The received driver data may indicate a state of the driver 102. In some examples, the driver data may include images of the driver 102 captured by the camera 110. In some examples, the received driver data may include biological data associated with the driver 102 (e.g., heart rate data). In other examples, the received driver data may include other data associated with the driver 102.

At step 408, the driver distraction determination module 310 determines whether the driver 102 is distracted based on the driver data received by the driver data reception module 308. In one example, the driver distraction determination module 310 determines that the driver 102 is distracted based on the direction of the gaze of the eyes of the driver 102 (e.g., whether the driver 102 is looking away from the screen 108). In other examples, the driver distraction determination module 310 may determine whether the driver 102 is distracted based on other metrics.

If the driver distraction determination module 310 determines that the driver 102 is not distracted (NO at step 408), then control returns to step 402, and the simulation continues. If the driver distraction determination module 310 determines that the driver 102 is distracted (YES at step 408), then control passes to step 410.

At step 410, the driving scenario generation module 300 generates a simulated driving event. The simulated driving event generated by the driving scenario generation module 300 may be a predetermined event to be tested during the simulation. For example, it may be desirable to test a particular assistive driving technology when a vehicle suddenly brakes in front of the simulated vehicle while the driver 102 is distracted. As such, once it is determined that the driver 102 is distracted, the driving scenario generation module 300 may simulate a leading vehicle suddenly braking. In other examples, the driving scenario generation module 300 may generate driving scenario data to simulate any particular driving event.

At step 412, after a particular driving event is simulated while the driver 102 is distracted, the assistive driving module 304 simulates operation of a particular assistive driving technology to be tested. For example, it may be desirable to test a collision avoidance system in the scenario discussed above, where a leading vehicle suddenly brakes. As such, in that example, the assistive driving module 304 may simulate operation of a collision avoidance system after it is determined that the driver 102 is distracted and the driving scenario to be tested has been simulated. The performance of the assistive driving technology may then be monitored by a human or machine to determine its performance. As such, this may give insight into the performance of the particular assistive driving technology, in a simulated environment, of a particular driving scenario when the driver 102 is distracted. Engineers may then make adjustments to improve the performance of the assistive driving technology accordingly.

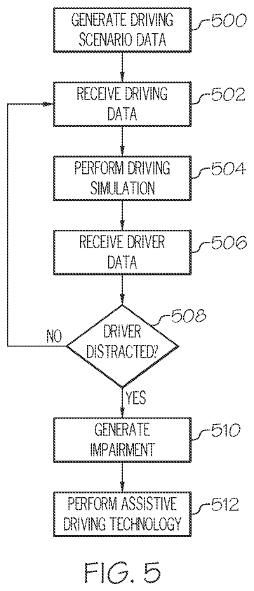

Turning now to FIG. 5, a flowchart is depicted of another example method of operating the driving simulator 100. At step 500, the driving scenario generation module 300 generates driving scenario data to be used to simulate a driving trip, in a similar manner as in step 400 of FIG. 4. At step 502, the driving data reception module 302 receives driving data based on driving actions performed by the driver 102, in a similar manner as in step 402 of FIG. 4. At step 404, the driving simulation module 306 simulates driving of a vehicle based on the driving scenario data generated by the driving scenario generation module 300 and the driving data received by the driving data reception module 302, in a similar manner as in step 404 of FIG. 4. At step 506, the driver data reception module 308 receives driver data from the driver monitor sensors 210, in a similar manner as in step 406 of FIG. 4.

At step 508, the driver distraction determination module 310 determines whether the driver 102 is distracted based on the driver data received by the driver data reception module 308, in a similar manner as in step 408 of FIG. 4. If the driver distraction determination module 310 determines that the driver 102 is not distracted (NO at step 508), then control returns to step 502. If the driver distraction determination module 310 determines that the driver 102 is distracted (YES at step 508), then control passes to step 510.

At step 510, the impairment generation module 312 generates an artificial impairment associated with the driver 102. The impairment may be a visual impairment of the images displayed on the screen 108 or an audio impairment output by one or more speakers in the driving simulator 100. As such, the impairment generation module 312 may cause the driver 102 to behave in a similar manner an impaired driver. At step 512, the assistive driving module 304 simulates operation of a particular assistive driving technology to be tested, in a similar manner as in step 412 of FIG. 4

It should now be understood that embodiments described herein are directed to adversarial simulation for developing and testing assistive driving technology. A driver is monitored in a driving simulator to determine when the driver becomes distracted. Once the driver becomes distracted, a particular driving event may be simulated such that assistive driving technology can be tested. By generating a driving event when the driver is actually distracted, the assistive driving technology can be tested in a realistic distracted driving scenario, thereby allowing for a more accurate analysis of the performance of the assistive driving technology than in a more contrived situation.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A driving simulator comprising a controller programmed to:
simulate operation of a vehicle being driven by a driver, the vehicle including assistive driving technology;
receive driver data associated with the driver;
determine whether the driver is distracted based on the driver data; and
upon determination that the driver is distracted, simulate a particular driving event.

2. The driving simulator of claim 1, wherein the controller is further programmed to:
receive the driving data comprising driving actions performed by the driver; and
simulate operation of the vehicle based on the driving data.

3. The driving simulator of claim 1, wherein the controller is further programmed to:
generate driving scenario data; and
simulate operation of the vehicle based on the driving scenario data.

4. The driving simulator of claim 3, wherein the driving scenario data comprises locations of objects and behavior of other road agents in a simulated environment.

5. The driving simulator of claim 1, wherein the driver data comprises one or more images of the driver.

6. The driving simulator of claim 5, wherein the controller is further programmed to:
determine whether the driver is distracted based on a direction of a gaze of the eyes of the driver.

7. The driving simulator of claim 1, wherein the driver data comprises biological data associated with the driver.

8. The driving simulator of claim 1, wherein the controller is further programmed to:
perform operation of the assistive driving technology after simulating the particular simulated driving event.

9. A method comprising:
simulating operation of a vehicle being driven by a driver, the vehicle including assistive driving technology;
receiving driver data associated with the driver;
determining whether the driver is distracted based on the driver data; and
upon determination that the driver is distracted, simulating a particular driving event.

10. The method of claim 9, further comprising:
receiving driving data comprising driving actions performed by the driver; and
simulating operation of the vehicle based on the driving data.

11. The method of claim 9, further comprising:
generating driving scenario data; and
simulating operation of the vehicle based on the driving scenario data.

12. The method of claim 11, wherein the driving scenario data comprises locations of objects and behavior of other road agents in a simulated environment.

13. The method of claim 9, wherein the driver data comprises one or more images of the driver.

14. The method of claim 13, further comprising:
determining whether the driver is distracted based on a direction of a gaze of the eyes of the driver.

15. The method of claim 9, wherein the driver data comprises biological data associated with the driver.

16. The method of claim 9, further comprising:
performing operation of the assistive driving technology after simulating the particular simulated driving event.

17. A driving simulator comprising a controller programmed to:
simulate operation of a vehicle being driven by a driver, the vehicle including assistive driving technology;
receive driver data associated with the driver;
determine whether the driver is distracted based on the driver data; and
upon determination that the driver is distracted, generate an impairment associated with the driver.

18. The driving simulator of claim 17, wherein the controller is further programmed to:
simulate operation of the vehicle by displaying an image associated with a state of the vehicle; and
generate the impairment by degrading the quality of the image.

19. The driving simulator of claim 17, wherein the controller is further programmed to:
simulate operation of the vehicle by outputting audio associated with a state of the vehicle; and
generate the impairment by degrading the quality of the audio.

20. The driving simulator of claim 17, wherein the controller is further programmed to:
simulate operation of the vehicle by receiving driving data comprising driving actions performed by the driver; and
generate the impairment by altering the received driving data.
